(19) United States
(12) Patent Application Publication
(10) Pub. No.: US 2014/0097630 A1
(43) Pub. Date: Apr. 10, 2014

(54) LOAD TRANSFER DEVICE

(71) Applicant: Mathew Kevin HEYDON, Australind (AU)

(72) Inventor: Mathew Kevin HEYDON, Australind (AU)

(21) Appl. No.: 14/038,036

(22) Filed: Sep. 26, 2013

(30) Foreign Application Priority Data
Sep. 26, 2012 (AU) 2012904214
Apr. 12, 2013 (AU) 2013204595

(51) Int. Cl. B66C 1/34; B66C 1/22

(52) U.S. Cl. CPC B66C 1/34; B66C 1/22
USPC 294/82.11; 294/215

(57) ABSTRACT

A load transfer device for attachment to a good to be moved via a plurality of wires, the load transfer device including a body having a first fastener and a second fastener. The first fastener is adapted to attach the load transfer device to the good and the second fastener is adapted for attachment of the plurality of wires. The second fastener is pivotally attached to the body of the load transfer device

### CROSS REFERENCE TO RELATED APPLICATION(S)

This application claims priority from Australian patent application no's. 2013204595 filed on Apr. 12, 2013 and 2012904214 filed on Sep. 26, 2012, the disclosures of which are incorporated herein in their entirety by reference.

### TECHNICAL FIELD

The present invention relates to systems for handling goods such as, for example, manufactured products, machinery, packages or containers.

The invention has been devised particularly, although not necessarily solely, in relation to system for moving goods within warehouses, shops or factories as well as for transferring loads from a crane to block for, for example, heavy construction and plant maintenance

### BACKGROUND ART

The following discussion of the background art is intended to facilitate an understanding of the present invention only. The discussion is not an acknowledgement or admission that any of the material referred to is or was part of the common general knowledge as at the priority date of the application.

The movement of goods such as, for example, manufactured products, machinery, packages or containers within warehouses or shops are a common procedure. Movement of the good from a first location to a second location is typically accomplished by attaching the good at two points. A first point is located above the good to be moved. The second point is located above the location to which the good will be moved. For this, first ends of wires or chains are attached to the first and second points and second ends of the wires are attached to the good to be moved. The procedure for moving the goods consists in raising the good from the floor at the first location and forwarding the good towards the second location. At the second location, the good is lowered onto the ground or placed in situ. Forwarding the good towards the second location may be done by pushing the good or by pulling the good via the wire or chain which is attached to the second spot or fleeting between two chain blocks. If required, the previously described process may be repeated in order to move the good to a third location. Further, this process may be repeated in order to move the good along relatively large distances.

The previously described process is cumbersome. This is particularly true in view of the large weight of the goods which are typically moved within warehouse or shops. The fact that the good is relatively heavy makes it difficult to push or pull the good after it has been raised from the floor at the first location in order to forward the good to the second location. Also, there is a tendency of the good to swing back to the first location after the good has been pushed or pulled towards the second location. This can be a safety hazard for the personnel that are moving the good.

Moreover, typically, second chains are directly attached to the good. The above mentioned wires or chains are then attached to these second chains. The presence of these second chains can also make it difficult to move the good from one location to another location. This is particularly true, in view that after the good has been raised from the floor the good is free to rotate. The rotation of the good, typically, twists the second chains. Twisting of the second chains can be dangerous in view of the tendency of the chains to try to un-twist themselves. The tendency of un-twisting of the chains can make the good to rotate which can be a safety hazard to the personal moving the good.

It is against this background that the present invention has been developed.

SUMMARY OF INVENTION

According to a first aspect of the invention there is provided a load transfer device for attachment to a good to be moved via a plurality of wires, the load transfer device comprising a body having a first fastening means (first fastener) and a second fastening means (second fastener), the first fastening means being adapted to attach the load transfer device to the good and the second fastening means being adapted for attachment of the plurality of wires, wherein the second fastening means is pivotally attached to the body of the load transfer device.

Preferably, the load transfer device comprises a transfer block.

Preferably, the second fastening means is rotatably attached to the body of the load transfer device.

Preferably, the second fastening means is rotatably attached to the body of the load transfer device such that the disk is adapted to rotate around a transversal axis of the body.

Preferably, the second fastening means comprises a plurality of openings adapted to receive ends of the plurality of wires.

Preferably, the openings are arranged around the second fastening means at spaced apart locations with respect to each other, each opening being separated from its adjacent opening by the same angular distance. In this manner, the openings define a Y shaped arrangement.

Preferably, the second fastening means comprises a disk.

In an alternative arrangement the second fastening means comprises a triangular plate.

Preferably, the first fastening means is releasably attached to the body of the load transfer device.

Preferably, the first fastening means is rotatably attached to the body of the load transfer device.

Preferably, the second fastening means comprises a swivel joint adapted to receive the first fastening means.

Preferably, the first fastening means is releasably attached to the swivel joint.

Preferably, the first fastening means comprises a hook.

Preferably, the first fastening means comprises a u-shaped piece having a pin, the u-shaped piece being adapted to attach the good to the load transfer device by removing and reattaching the pin for attachment of the good to the u-shaped piece.

In a further alternative arrangement, the second fastening means comprises a body having a centre section and a plurality of rings attached to the centre section, the rings being adapted to receive ends of the plurality of wires.

Preferably, the rings are arranged around the centre section at spaced apart locations with respect to each other, each ring being separated from its adjacent ring by the same angular distance. In this manner, the body of the second fastening means define a Y-shaped arrangement.

Preferably, each ring is rotatably attached to the centre section allowing rotation of each ring around a radial axis of the centre section.

Preferably, the first fastening means comprises a u-shaped piece having a pin, the u-shaped piece being adapted to attached the good to the load transfer device by removing and reattaching the pin for attachment of the good to the u-shaped piece.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 shows the process in accordance with a first embodiment of the invention for moving a good;

FIG. 2 is a schematic view of a transfer block in accordance with the first embodiment of the invention;

FIG. 3 is a schematic view of a fastening means to of the transfer block shown in FIG. 2;

FIG. 4 is schematic view of a transfer block in accordance with the second embodiment of the invention;

FIG. 5 is a schematic view of a detail of a particular arrangement of a transfer block in accordance with the second embodiment of the invention.

FIG. 6 is a schematic view of a transfer block in accordance a second arrangement of the first embodiment of the invention; and

FIG. 7 is a schematic side view of a transfer block shown in FIG. 6.

### DESCRIPTION OF EMBODIMENTS

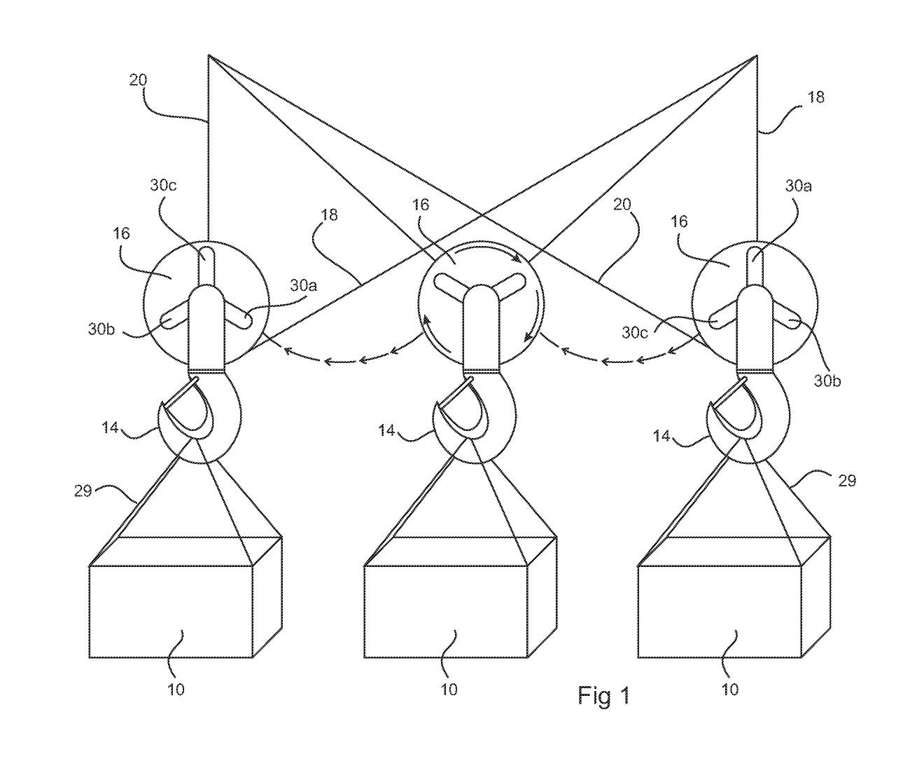

FIG. 1 shows the process in accordance with an embodiment of the invention of moving a good 10 from a first location to a second location. The process in accordance with the present embodiment may be used for transferring goods within warehouse or shops. The process in particular facilitates moving heavy loads such as machinery, finalised products, packages or containers within a warehouse or shops. The process includes using a transfer block 12 which allows raising the good 10 from the floor at a first location and forwarding the good 10 to a second location. The transfer block 12 in accordance with embodiments of the invention comprises fastening means which is pivotally attached to the transfer block 12. As will be described with reference to the method of operation of the transfer block 12 the fact that fastening means is pivotally attached to transfer block 12 facilitates the process of moving of the good 10.

Referring to FIG. 1, the transfer block 12 comprises a first fastening means 14 for attaching the good 10 to the transfer block 12 and second fastening means 16 for attaching the transfer block 12 to places adjacent the location at which the good 10 is located (the first location) and the location to which the good 10 is being moved to the second location. In particular, first and second wires 18 and 20 join the transfer block 12 to the places located adjacent the first and second locations. As shown in FIG. 1, an end of the first wire 18 is attached to an area located above the first location and an end of a second wire 20 is attached to an area located above the second location. The other ends of the first and second wires 18 and 20 are attached to the second fastening means 16 of the transfer block 12. The good 10 is moved from the first location to the second location by lifting the good 10 from the floor and forwarding the good 10 towards the second location. At the second location, the good 10 may be lowered unto the floor and the transfer block 12 can be detached from the good 10.

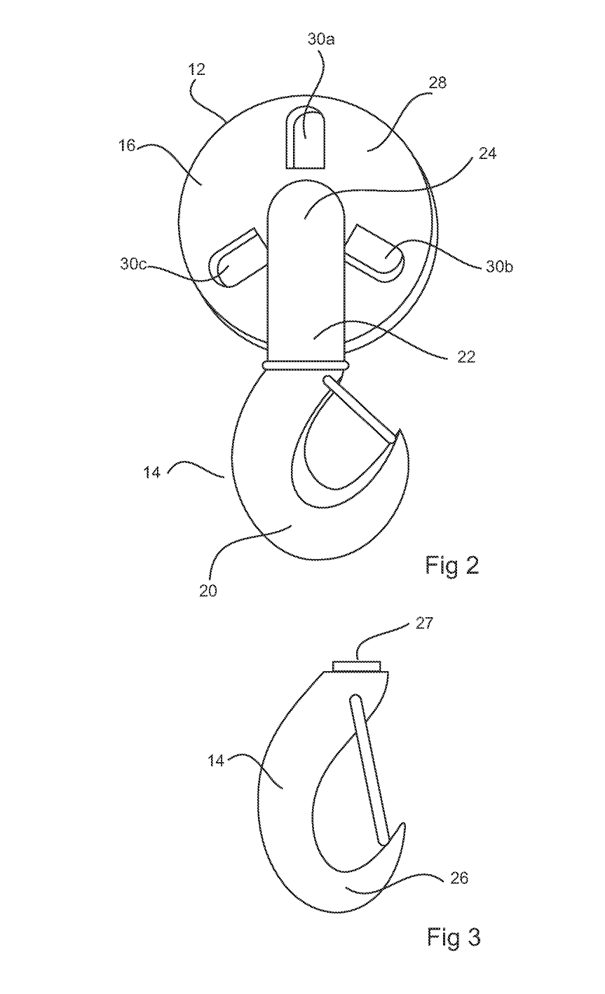

FIG. 2 shows a transfer block 12 in accordance with a first embodiment of the invention. The transfer block 12 comprises a body 20 adapted to receive the first and second attachment means 14 and 16. The body 20 comprises a first end section 22 and a second end section 24.

The first end section 22 is adapted for pivotally attaching the first fastening means 14 to the body 20. The fact that the first fastening means 14 is pivotally attached to the body 20 allows the first fastening means 14 to rotate around the longitudinal axis of the body 20. The second end section 24 is adapted for pivotally attaching the second fastening means 16 to the body 20. The second fastening means 16 is pivotally attached to the end section 24 such that the second fastening means 16 can rotate around a transversal axis of the body 20.

In the particular embodiment shown in FIG. 1, the first fastening means 14 comprises a hook 26. The hook 26 allows attachment of the good 10 via, for example, wires 29. However, any type of fastening means 14 may be used for attaching the good 10. In particular arrangements of the embodiments of the invention the first fastening means 14 may be releasably attached to the body 20. As shown in FIG. 3, the first fastening means 14 comprises means 27 for releasably attaching the fastening means 14 to the body 20 of the transfer block 12. This is particular advantageous because it allows attaching to the transfer block 12 different types of first fastening means 14 to, for example, suit the type of goods 10 that will be moved.

Further, the first fastening means 14 (such as, for example, the hook 36) may be rotatably attached to the body 20 of the transfer block 12. This allows the first fastening means 14 to rotate in order to conform to rotations of the good 10 during movement of the good 10. This avoids the wires 29 holding the good 10 to be twisted if the good 10 starts rotating during movement of the good 10 from the first location to the second location. For this, there may be included a swivel joint 50 which attaches the first fastening means 14 such that the first fastening means may swivel around the longitudinal axis of the transfer block 12. This can be best appreciated in FIG. 7.

As shown in FIG. 2, the second fastening means 14 comprises a disk 28. The disk 28 is pivotally attached to the second end section 24 of the body 20. In an arrangement of the present embodiment of the invention, the fact that the disk 28 is pivotally attached to the body 20 allows the disk 28 to rotate around the transversal axis of the body 20 of the transfer block 12.

The disk 28 comprises a plurality of openings 30. The openings 30 are arranged around the disk 28 at spaced apart locations with respect to each other. As shown in FIG. 2, there are three openings 30a, 30b and 30c. Each opening 30 is separated from its adjacent opening 30 by the same angular distance. In this manner, the openings 30 define a Y shaped arrangement.

The openings 30 are adapted to receive the wires 18 and 20. For attaching the ends of the wires 18 and 20 to the openings 30, the wires 18 and 20 may comprise fastening means such as, for example, hooks adapted to engage the openings 30. At least two of the openings 30 are adapted to receive wires 18 and 20; as shown in FIG. 1, the wire 18 is attached to the opening 30a and the wire 20 is attached to the opening 30c.

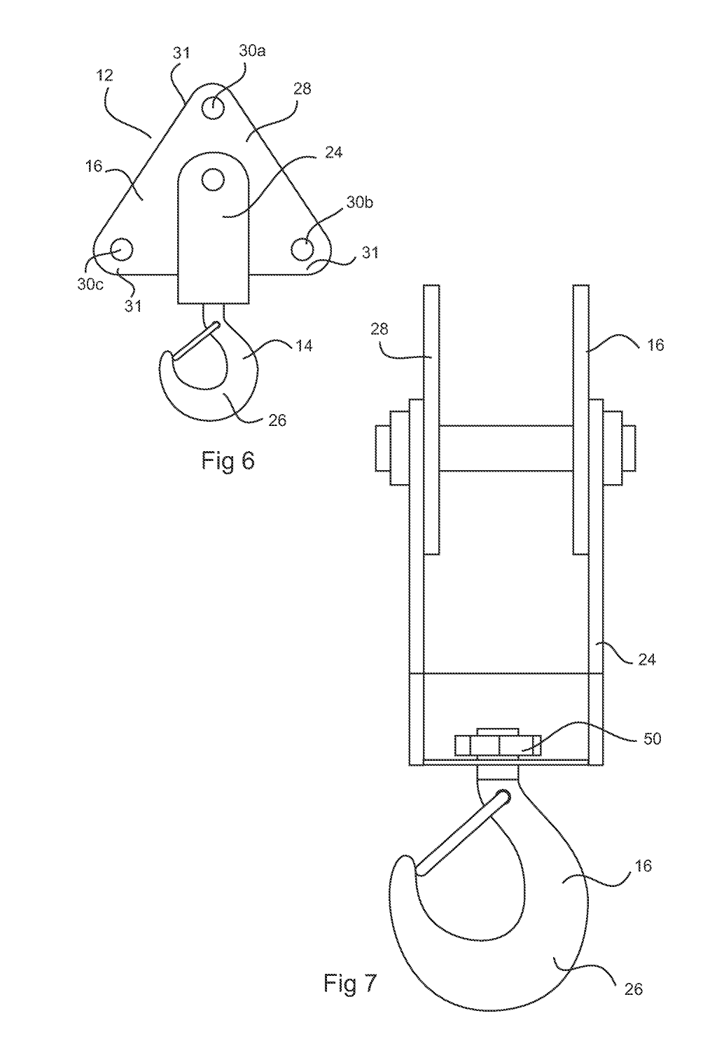

The second fastening means can have any shape. For example, FIG. 6 shows an alternative arrangement of the second fastening means 14. The second fastening 14 in accordance with the second arrangement comprises a triangular plate 28. The triangular plate 28 includes vertices 31. Each of the opening 30 is located within vertices 31.

As mentioned before, the transfer block 12 facilitates moving a good 10 from a first location to a second location. For moving the good 10, there are provided two wires 18 and 20. The wire 18 is attached to a location above the good 10. For example, the wire 18 may be attached to a crane (not shown). The crane allows raising the good 10 from the floor. The wire 20 is attached to a location above the location to which the good 10 will be moved. The wire 20 may be attached to a chain box (not shown). As will be described with reference to the process of moving the good 10, the chain box allows pulling the good 10 to the second location.

Referring to FIG. 1, the process for moving the good 10 comprises the steps of attaching the transfer block 12 to the good 10 and attaching the wires 18 and 20 to the openings 30a and 30b of the transfer block 12. Subsequently, the good 10 is raised from the floor by pulling at the wire 18. Pulling of the wire 18 may be accomplished via the crane (not shown) to which the wire 18 is attached.

When the good 10 is located above the floor, the good 10 may be moved from the first location to the second location. At the second location, the good 10 may be lowered unto the floor and the transfer block 12 can be detached from the good 10.

During movement of the good 10, the disk 28 of the transfer block 12 rotates. This rotation changes the angular location of the openings 30 during displacement of the good 10 from the first location to the second location. Thus, rotation of the disk 28 changes the positions of openings 30a, 30b and 30c. As shown in FIG. 1, when the good 10 is at the first location, the opening 30a is located in a vertical position and the opening 30c is located at an angle from the vertical position. After the good 10 has been moved to the second location, the opening 30a has been displaced to a position at an angle from the vertical position and the opening 30b has been displaced to the vertical position.

As can be seen from FIG. 1, the fact that the disk 28 rotates allows that during forwarding of the good 10 to the second location the good 10 stays at the same height with respect to the floor during the displacement of the good 10 from the first location to the second location. The fact that the good 10 stays at the same height facilitates moving of the good 10.

The process for moving the good 10 described above may be repeated in order to move the good 10 along relatively large distances. For this, the good 10 when located in the second location, the crane is moved adjacent the second location and the chain box is moved to a location above a third location (towards which the good 10 will be moved). This allows the good 10 to be re-attached to the crane via the wire 18 and to the chain box via the wire 20. This allows moving the good 10 from the second location to the third location. This process may be repeated as many times as necessary to move the good 10 from the first location to a location separated a relatively large distance from the first location.

As was indicated before, use of the transfer block 10 facilities moving relatively large loads from one location to another location. In particular, the fact that the transfer block comprises a second fastening means 16 (such as the disk 28) which is pivotally attached to the transfer block 12 facilitates moving the good 10. This is because the fact that the second fastening means 16 is adapted to pivot allows movement of the locations at which the wires 18 and 20 are attached to the second fastening means 16 during movement of the good 10 (see FIG. 1). This movement of the locations at which the wires 18 and 20 are attached to the second fastening means 16 facilitates displacing the good 10 from the first to the second location. As mentioned before, rotation of the second fastening means 16 allows the good 10 to stay at the same height with respect to the floor. The fact that the good stays at the same height facilitates pushing or pulling of the good 10 during movement of the good 10.

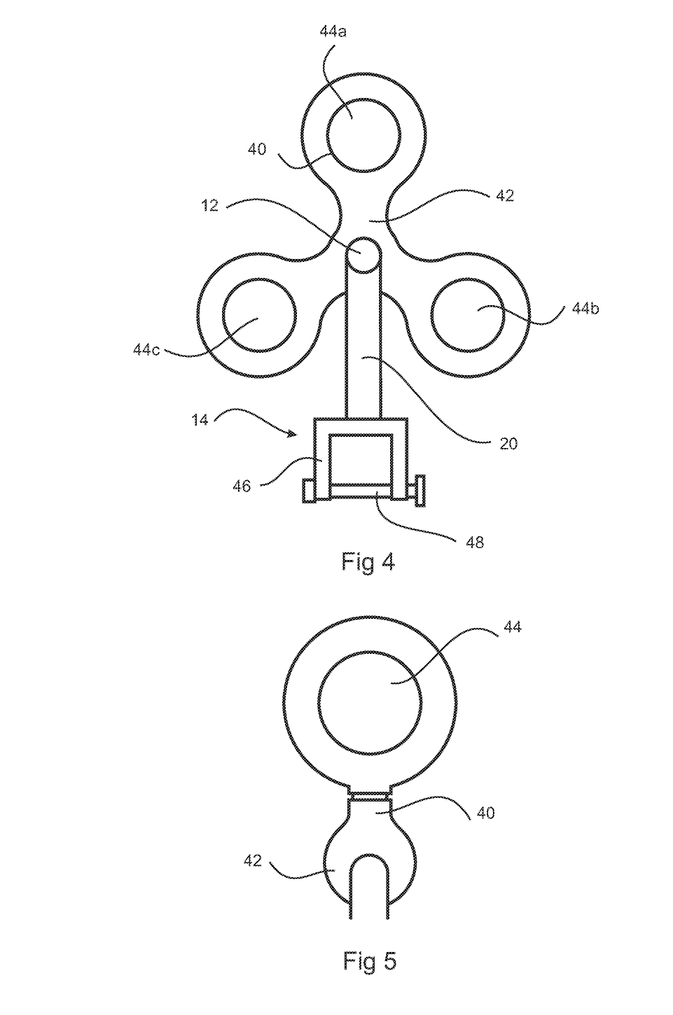

FIG. 4 shows a transfer block 12 according to a second embodiment of the invention. The transfer block 12 according to the second embodiment is similar to the transfer block 12 according to the apparatus of the first embodiment and similar reference numerals are used to identify similar parts. In this second embodiment the second attachment means 16 comprises a body 40 adapted to receive the wires 18 and 20. The body 40 comprises a centre section 42 and a plurality of rings 44a, 44b and 44c. The rings 44 are attached at the centre section 42 at spaced apart locations. The centre section 42 is pivotally attached to the body 20 of the transfer block 12. In an arrangement of the present embodiment of the invention, the fact that the centre section 42 is pivotally attached to the body 20 allows the body 40 to rotate around the transversal axis of the body 20 of the transfer block 12.

Referring to FIG. 5, in accordance with particular arrangements, the rings 44 may be rotatably attached to the centre section 42. This allows the rings 44 to rotate in order to conform to any change of orientation of the wires 18 and 20.

Further, as shown in FIG. 5, the first fastening means 14 in accordance with the second embodiment of the invention comprises a u-shaped piece 46 having a pin 48. This fastening means 14 allows attachment of the good 10 by removing and reattaching the pin 48 for attachment of the good 10 to the u-shaped piece. However, as indicated with reference to the first embodiment of the invention the first attachment means 14 may be releasably attached to the body 20 of the transfer block 12. Thus, any fastening means (such as, for example, a hook 26) may be attached to the transfer block 12 in accordance with the second embodiment of the invention. Similarly, the first fastening means 14 in accordance with the second embodiment of the invention shown in FIG. 4 may be replaced with the hook 26 shown in FIGS. 2 and 3.

Modifications and variations as would be apparent to a skilled addressee are deemed to be within the scope of the present invention.

Further, it should be appreciated that the scope of the invention is not limited to the scope of the embodiments disclosed.

Throughout this specification, unless the context requires otherwise, the word “comprise” or variations such as “comprises” or “comprising”, will be understood to imply the inclusion of a stated integer or group of integers but not the exclusion of any other integer or group of integers.

1-18. (canceled)

19. A load transfer device for attachment to a good to be moved via a plurality of wires, the load transfer device comprising a body having a first fastener and a second fastener, the first fastener being adapted to attach the load transfer device to the good and the second fastener being adapted for attachment of the plurality of wires, wherein the second fastener is pivotally attached to the body of the load transfer device.

20. A load transfer device according to claim 19 wherein the load transfer device comprises a transfer block.

21. A load transfer device according to claim 19 wherein the second fastener is rotatably attached to the body of the load transfer device.

22. A load transfer device according to claim 19 wherein the second fastener is rotatably attached to the body of the load transfer device such that the disk is adapted to rotate around a transversal axis of the body.

23. A load transfer device according to claim 19 wherein the second fastener comprises a plurality of openings adapted to receive ends of the plurality of wires.

24. A load transfer device according to claim 23 wherein the openings are arranged around the second fastener at spaced apart locations with respect to each other, each opening being separated from its adjacent opening by the same angular distance.

25. A load transfer device according to claim 19 wherein the second fastener comprises a disk.

26. A load transfer device according to claim 19 wherein the second fastener comprises a triangular plate.

27. A load transfer device according to claim 19 wherein the second fastener comprises a body having a centre section and a plurality of rings attached to the centre section, the rings being adapted to receive ends of the plurality of wires.

28. A load transfer device according to claim 27 wherein the rings are arranged around the centre section at spaced apart locations with respect to each other, each ring being separated from its adjacent ring by the same angular distance.

29. A load transfer device according to claim 19 wherein each ring is rotatably attached to the centre section allowing rotation of each ring around a radial axis of the centre section.

30. A load transfer device according to claim 19 wherein the second fastener comprises a swivel joint adapted to receive the first fastener.

31. A load transfer device according to claim 30 wherein the first fastener is releasably attached to the swivel joint.

32. A load transfer device according to claim 19 wherein the first fastener comprises a hook.

33. A load transfer device according to claim 19 wherein the first fastener comprises a u-shaped piece having a pin, the u-shaped piece being adapted to attached the good to the load transfer device by removing and reattaching the pin for attachment of the good to the u-shaped piece.

34. A load transfer device according to claim 19 wherein first fastener is releasably attached to the body of the load transfer device.

35. A load transfer device according to claim 19 wherein first fastener is rotatably attached to the body of the load transfer device.
